(19) United States
(12) Patent Application Publication
(10) Pub. No.: US 2024/0145940 A1
(43) Pub. Date: May 2, 2024

(54) COMBINED WIDE BEAMWIDTH MULTIBAND ANTENNA AND METHOD OF ASSEMBLING SAME

(71) Applicant: NETQUI j.s.a., Humenne (SK)

(72) Inventors: Martin Marcincak, Humenne (SK); Miroslav Vrabel, Lubina (SK); Pavol Capek, Stupava (SK); Peter Svihura, Humenne (SK)

(73) Assignee: NETQUI j.s.a., Humenne (SK)

(21) Appl. No.: 18/496,435

(22) Filed: Oct. 27, 2023

Related U.S. Application Data
(60) Provisional application No. 63/420,381, filed on Oct. 28, 2022.

(51) Int. Cl. H01Q 21/28; H01Q 1/22; H01Q 13/02

(52) U.S. Cl. CPC H01Q 21/28; H01Q 1/22; H01Q 13/025; H01Q 13/0283

(57) ABSTRACT

A wide beamwidth antenna formed as a combination of multiple independent antenna subsystems into a compact assembly. Antenna subsystems are selected of types to have minimal mutual coupling. A primary antenna, typically for the higher frequency bands (i.e 5-6 GHz) is preferably a of a horn-type antenna, secondary antennas (i.e. 2.4 GHz) are typically of a flat (planar) and/or compact type (i.e. electrically short) such as monopole, dipole, loop, patch, slot or other suitable compact and/or flat antennas (i.e. inverted F—PIFA, MIFA, fractal antenna etc.). Both primary and secondary antennas coexist on one shared mechanical body and RF feeders of both primary and secondary antennas are integrated on a single shared PCB, also carrying the RF application circuitry.

This application claims priority from and the benefit of U.S. provisional patent application Ser. No. 63/420,381 filed on Oct. 28, 2022, which is incorporated herein by reference, in its entirety, for all purposes.

### BACKGROUND OF THE DISCLOSURE

### 1. Field of the Disclosure

The present disclosure generally relates to electromagnetic antennas. More particularly, the present disclosure relates to multiple band antennas combining multiple different antenna subsystems into a single compact assembly, where at least one antenna is of horn type.

### 2. Description of the Related Art

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Indoor and short-range outdoor applications usually use quarter wave, dipole or patch antennas or arrays thereof. This typically leads to poor coverage and interference issues caused by ‘dirty’ radiation patterns of such antennas having strong side and back lobes. Thus, antennas radiate to create interference to, and receive interference from, unwanted areas. Performance is often further negatively affected by RF losses and poor overall efficiency caused by lossy coaxial connections between antennas and RF electronics, long/complex feeding network with dividers in the case of arrays, lossy materials (for example, FR4 in case antennas implemented on printed circuit boards (PCBs) as a price compromise), which is most prevalent especially in the 5 GHz and 6 GHz bands.

### SUMMARY OF THE DISCLOSURE

Several embodiments of antennas to solve the above-mentioned problems are disclosed herein. A waveguide based horn can be a primary antenna, typically for 5 GHz and/or 6 GHz bands, designed to have substantially wide coverage (for example, greater than 60° at −3 dB) as is needed for a given application. Clean, well defined radiation patterns with very low side and back lobes can be achieved, with high overall efficiency of low-loss waveguide horns, supported by locating excitation of the feeding waveguide directly onto a single, common radio frequency printed circuit board (PCB). The PCB also can contain the RF application circuitry so that connection to RF ports (RF electronics—RX LNA, TX PA) is provided with short connections and thus there are minimum possible losses. Thus, both primary and secondary antenna ports can be located on the PCB so that radio frequency electronic components (such as chips or circuits on the PCB) can be efficiently connected to these ports

More specifically, the excitation feeder of the horn antenna is realized as a planar structure on the printed circuit board (PCB), onto which also are located RF ports of secondary antennas. The PCB also can carry application circuitry, i.e a WiFi device (WiFi AP/router/station etc.), cellular network device (base station, CPE, eNodeB, gNodeB etc.) or a WiGig (60 GHz mmw) device, as required for a particular application. This single PCB approach offers advantages in easy manufacturing with high yield and low unit to unit variations.

The primary horn antenna, having a throat of preferably symmetric cross-section (typically circular, square, or a combination of these shapes), can be excited in multiple polarizations, as is known to those skilled in art; i.e. dual linear (VH or slant), circular and combinations thereof, supporting multiport applications such as MIMO.

The primary horn antenna can be designed as broadband, to operate in multiple frequency bands, i.e. to operate in both 5 GHz and 6 GHz bands, in multiple or even all of the U-NII bands (U-NII-1, 5.15-5.25 GHz to U-NII-8, 6.875-7.125 GHz)

The primary antenna can be single or in the form of multiple sub-antennas, as needed for a given application, i.e. two or more wave guide WG horn antennas. When the multiple antennas are located in the same plane, these can be formed as a single mechanical unit with completely separated or partially overlapping horn structures, behind which is located the PCB, allowing for the shortest possible RF connection of the antenna RF ports to RF application circuitry (RX LNA, TX PA).

Similarly, multiple horn antennas, each in different frequency bands (5 GHz, 6 GHz or other bands) could be used when the application requires simultaneous concurrent operation in multiple bands/sub-bands. This can be achieved with higher mutual isolation than is possible to achieve using a wideband horn antenna design combined with RF filtering. When spatial separation is demanded; and/or a higher number of MIMO chains are utilized by the device, the embodiments disclosed herein provide better performance than is possible to achieve by using multiple different (mutually orthogonal) polarizations of a single horn antenna.

The disclosed embodiments utilize waveguides to make RF filtering easier, by suppressing unwanted frequencies that are lower than the critical frequency of a particular primary horn antenna waveguide determined by dimensions of the waveguide, and which can be designed to suit a particular application.

The secondary antennas, for example, for the 2.4 GHz band (or other bands) are then mechanically combined with the primary horn antenna, selected from types, and placed on suitable locations to have minimal mutual coupling without degrading performance of either the primary or secondary antennas. Typically, the flat portions of the primary horn antenna structure serve as ground planes for the secondary antennas.

The secondary antenna can be single or in the form of multiple sub-antennas, arranged to suit a particular application, i.e. for MIMO, beamforming/beam steering, or to form an antenna array with a higher gain. Secondary antennas have their ports preferably in a form compatible with the PCB technology used, as described below.

### BRIEF DESCRIPTION OF THE DRAWINGS

It is noted that in the specific embodiments or examples described below, a plurality of secondary antennas are shown. However, in some applications, it is possible to use a single secondary antenna. Thus, the term “at least one” covers the cases of both a single secondary antenna, and the case of a plurality of secondary antennas.

Depending on the frequency ranges being used, in some cases the horn antenna may serve as a ground plane for the secondary antenna or antennas.

FIG. 1 is a perspective view of a combined antenna embodiment with four secondary antennas oriented perpendicularly to a central, longitudinal axis.

FIG. 2 is a front view of the combined antenna embodiment with four secondary antennas oriented perpendicularly to a central, longitudinal of FIG. 1.

FIG. 3 is cross-sectional view of the combined antenna embodiment with four secondary antennas of FIG. 1.

FIG. 4A and FIG. 4B are, respectively, perspective off-axis (left) and axial (right) sectional views (of a combined antenna instance), embodiment with four secondary antennas oriented perpendicularly, of that of FIG. 1.

FIG. 5 is a perspective view (of a combined antenna instance), embodiment with four secondary antennas oriented in parallel.

FIG. 6 is a front view of the embodiment of FIG. 5.

FIG. 7A and FIG. 7B are, respectively, perspective off-axis (left) and axial (right) sectional views (of a combined antenna instance), embodiment with four secondary antennas oriented in parallel, as in FIG. 5

FIG. 8 is a perspective off-axis sectional view of a combined antenna instance, showing detail of the secondary antenna, as in FIG. 7A.

FIG. 9 is a perspective axial sectional view of a combined antenna instance, showing detail of the secondary antenna as in FIG. 7B.

FIG. 10 is a perspective view (of a combined antenna instance), embodiment with two secondary antennas.

FIG. 11 is a front view of the combined antenna embodiment with two secondary antennas oriented perpendicularly to a central, longitudinal axis of FIG. 10.

FIG. 12 is a cross-sectional view of the combined antenna embodiment with two secondary antennas of FIG. 10.

FIG. 13 is a perspective view of a combined antenna instance, embodiment with two secondary antennas placed in horn trough or channel.

FIG. 14 is a sectional view of a combined antenna instance, embodiment with two secondary antennas placed in horn trough or channel, as in FIG. 13.

FIG. 15A and FIG. 15B are, respectively, perspective off-axis (right) and axial (left) sectional views, of the embodiment with two secondary antennas placed in horn trough or channel, as in FIG. 13.

FIG. 16 is a perspective off-axis sectional view of embodiment with two secondary antennas placed in horn trough or channel, showing detail of the secondary antenna, of the embodiment of FIG. 13.

FIG. 17 is a perspective axial sectional view of embodiment with two secondary antennas placed in horn trough or channel, showing detail of the secondary antenna of the embodiment of FIG. 13.

FIG. 18 is a perspective view of embodiment comprising two combined antenna instances of the type in FIG. 1.

FIG. 19 is a front view of embodiment comprising two combined antenna instances of the type in FIG. 1, as illustrated in FIG. 18.

FIG. 20A and FIG. 20B are, respectively, perspective off-axis (right) and axial (left) sectional view, embodiment comprising two combined antenna instances as in FIG. 19.

### DESCRIPTION OF THE PREFERRED EMBODIMENTS

In the various drawing figures, the same or like reference numerals indicate the same or like components, respectively.

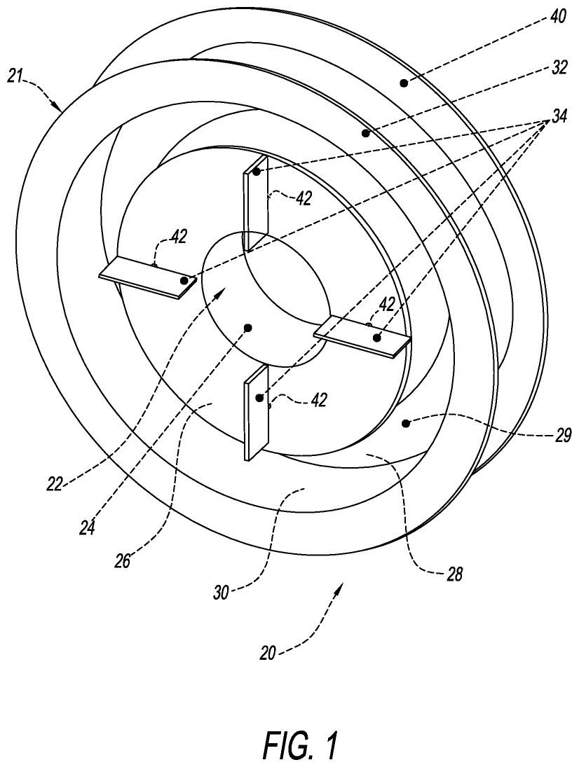

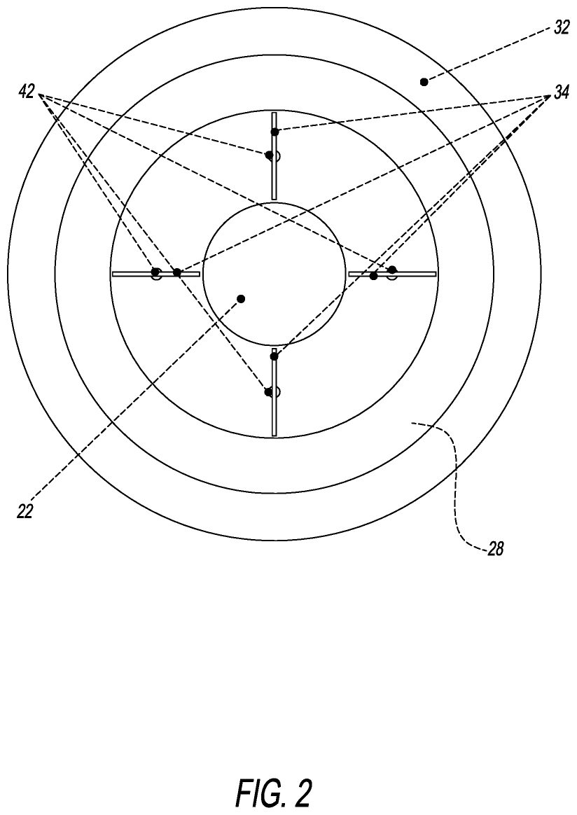

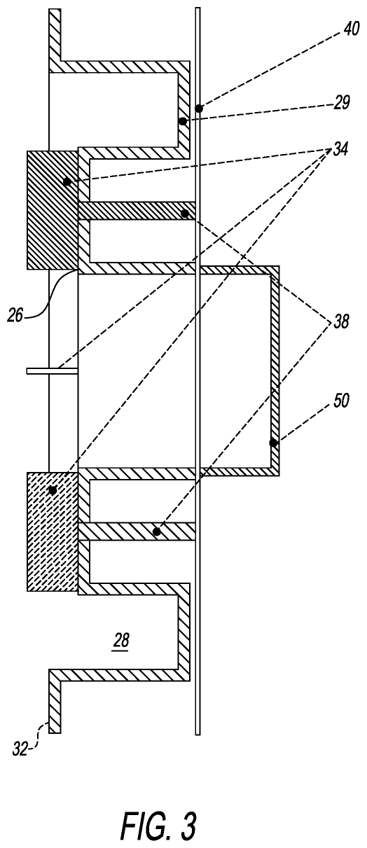

Referring FIG. 1, FIG. 2 and FIG. 3, a horn antenna 20, having a horn 21, formed of a conductive material such as a metal, may be of circular configuration, including a central opening shown generally as 22, defined by a surrounding wall 24 which also defines a raised annular platform 26. The outer circumference of platform 26 is surrounded by a preferably circular trough or recessed channel 28 with a bottom surface 29. The outer wall 30 of recessed channel 28 extends to a flange 32 defining the periphery of horn antenna 20.

Horn 21, as more fully described below, may be designed to radiate radio frequency energy at a primary frequency typically in a range in the 5 GHz and/or 6 GHz bands, designed to have substantially wide coverage (for example, greater than 60 degrees at −3 dB).

A plurality of secondary antennas 34 (for example, a total of four antennas, as in FIG. 1 and FIG. 2), configured to operate in the frequency range of approximately 2.4 GHz, are disposed on platform 26. Antennas 34 may be supported so as to be symmetrically disposed on platform 26, for example at ninety degree intervals. Antennas 34 may be of rectangular shape, extending from annular platform 26 and arranged so that a longitudinal axis of antennas 34 intersect a longitudinal axis of horn antenna 20. In general, these secondary antennas 34 can be of any suitable type, that allow for minimal mutual coupling without degrading performance of either the primary or secondary antennas. Typically (if the secondary antennas are in the 2.4 GHz band, and the primary horn is in the 5 and/or 6 GHz bands), electrically small antennas are preferred, such as, for example, those of the planar inverted-F antenna (PIFA) or ceramic chip antenna (SMT) design, but there is no limitation to a particular type of secondary antennas. The precise characteristics of antennas 34 are of secondary importance. However, antennas 34 must be of a size to fit into a combination with horn antenna 20. When working at a lower frequency than the horn, they are considered to be of electrically small types.

Referring to FIG. 3, each of antennas 34 is fed radio frequency excitation by a coaxial feed 38 extending through the body of horn antenna 20 from a circuit board 40 to which it may be connected using a suitable RF coaxial connector such as a micro-miniature coaxial (MMCX) connector or soldered directly. Each feed 38 extends through a respective circular opening 42 (shown in FIG. 2) in platform 26. In some designs, the secondary antenna feed 38 can perform as a post, mechanically holding a secondary antenna 34 in a desired position, as may be appropriate and suitable in some designs. Feed 38 can be of other suitable type which is compatible with PCB technology. Feed 38 can be a waveguide if the secondary antennas 34 are performing in a substantially higher frequency band than the band of the primary horn antenna 20.

Circuit board 40 may be configured with suitable RF conductors (coaxial, microstrip, stripline or SIW (substrate integrated waveguide)) to connect RF application circuitry to the secondary antenna ports and to the excitation ports of primary horn antenna 20, which both are located on the same single RF PCB. Connection can be through a connector (for example, secondary antennas sliding into the structure during manufacturing) or fixed (for example, secondary antennas soldered, or press-in fit into the structure during manufacturing) or by any other means required by the chosen manufacturing process.

Circuit board 40 covers one end of central opening 22, which acts as a waveguide to conduct radio frequency energy from circuit board 40 to be radiated by antenna 20. A waveguide shorting member 50 is affixed to circuit board 40 on the side opposite horn 21 so that energy provided from circuit board 40 is reflected to radiate from the front (mouth) of horn 21 of antenna 20. Shorting member 50 will have dimensions that suit the intended working frequency band (the critical frequency) as is well known to those skilled in art. The layout of the printed circuit board 40 around the waveguide may form a transition exciting the waveguide, using copper tracks or using conductive elements attached to the printed circuit board 40, as is also well known in the art. Possible forms of such transitions are also shown in U.S. Pat. No. 9,531,078.

More specifically, for example, and not by way of limitation, any known suitable, preferably planar or PCB-compatible structure, can be used. For example, by means of electric field (E) probe(s) formed directly on the PCB, in order to obtain two linear polarizations, two of such probes, perpendicular to each other in the waveguide cross section plane can form V/H or +/−45 degree slant polarizations, depending on orientation with respect to the horizon. Alternatively, the excitation probes can be external to the PCB (separate elements connected to the PCB) and inserted into or entering the waveguide cavity through holes in wall 24 of the waveguide.

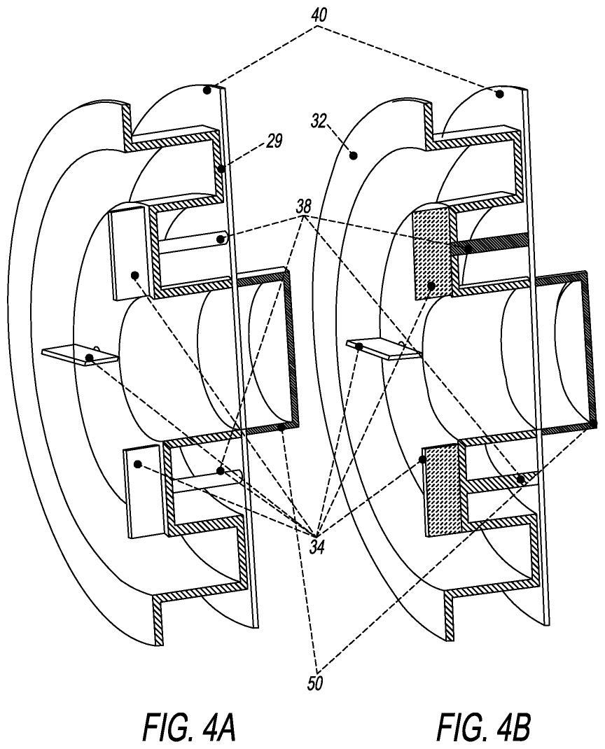

FIG. 4A and FIG. 4B, as perspective views, provide additional understanding of the special relationships of the components described above with respect to FIG. 1, FIG. 2 and FIG. 3. It is noted that feed 38 is a simplified representation of a feed connection between the PCB 40 and antennas 34, which for example, can be in coaxial form. However, for simplicity, details such as a center pin and its insulator are not shown. As discussed above, it is possible to use other suitable feed connections.

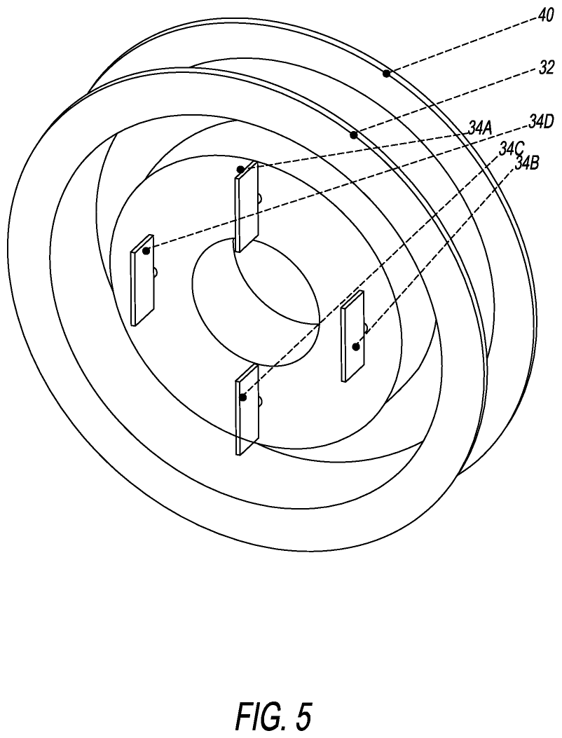

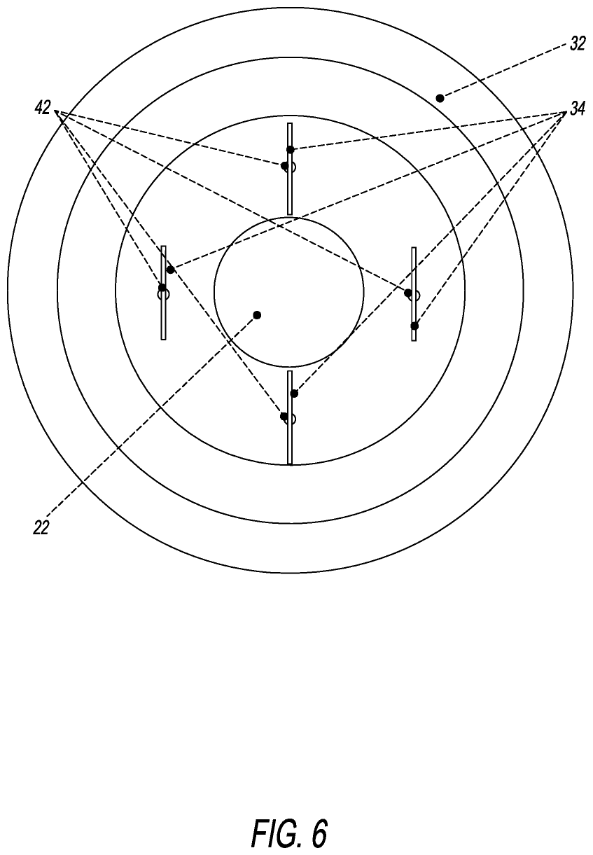

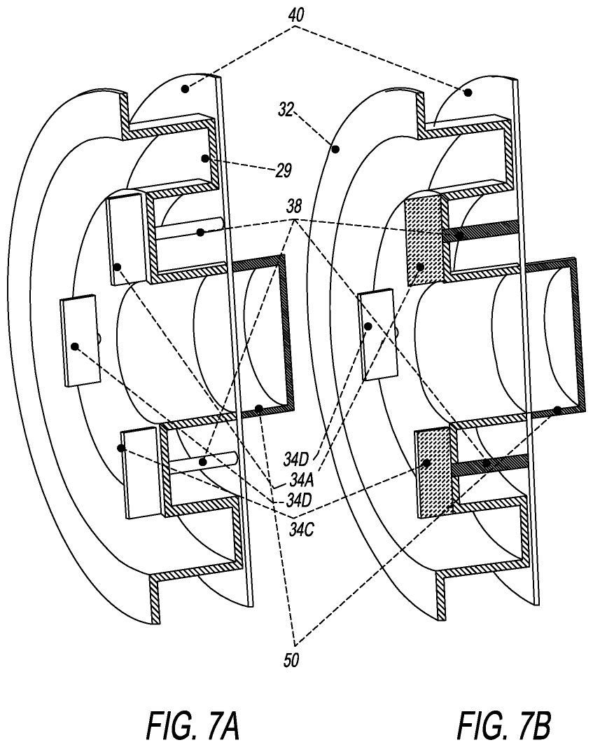

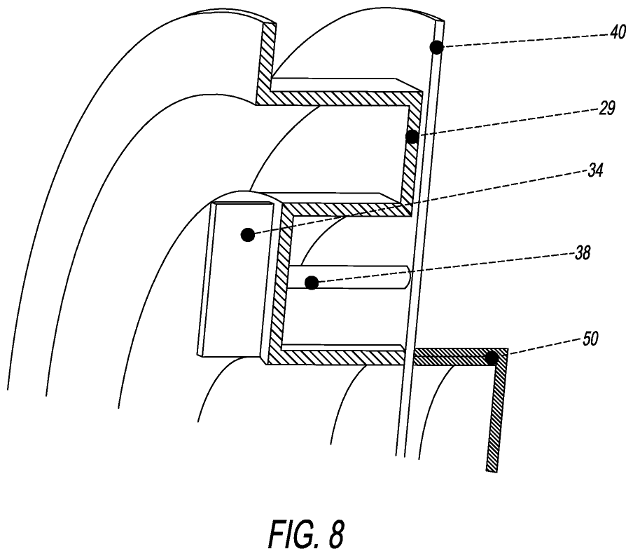

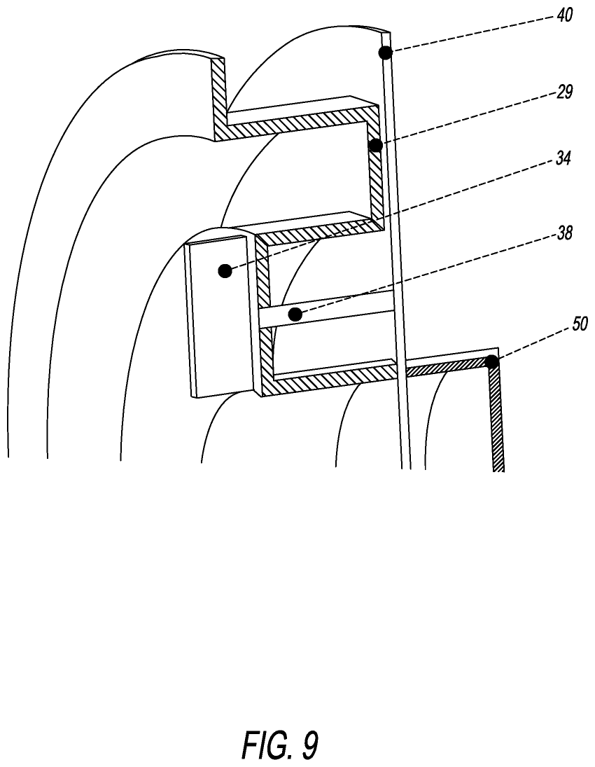

Referring to FIG. 5, FIG. 6, FIG. 7A, FIG. 7B, FIG. 8 and FIG. 9, illustrate an embodiment having four secondary antennas 34A, 34B, 34C and 34D arranged on platform 26 so that the length of antennas 34 all extend in a direction parallel to one another along lines that are perpendicular to the central axis of horn 21. The length of antennas 34A and 34C are on the same such line, with that line extending through the central axis of horn 21. Antennas 34B and 34C are symmetrically disposed at equal distances from the central axis of horn 21.

FIG. 7A, FIG. 7B, FIG. 8 and FIG. 9 provide additional understanding of the special relationships of the components described above with respect to FIG. 5, FIG. 6, FIG. 7A and FIG. 7B.

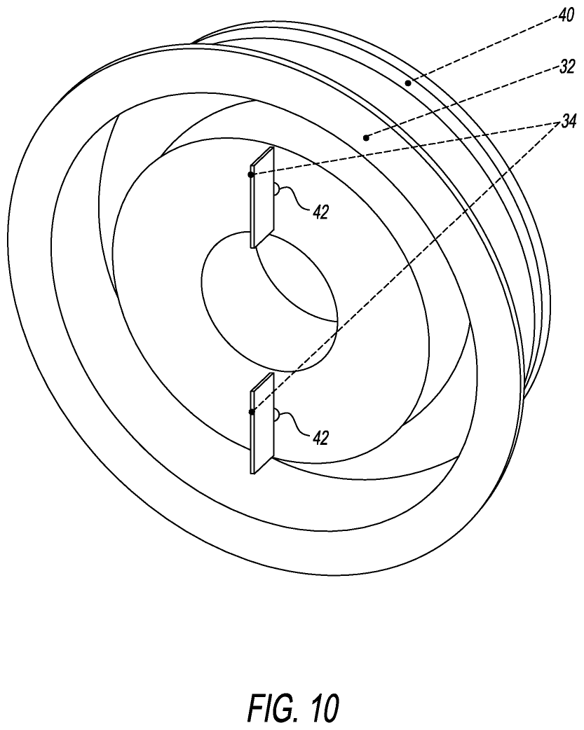

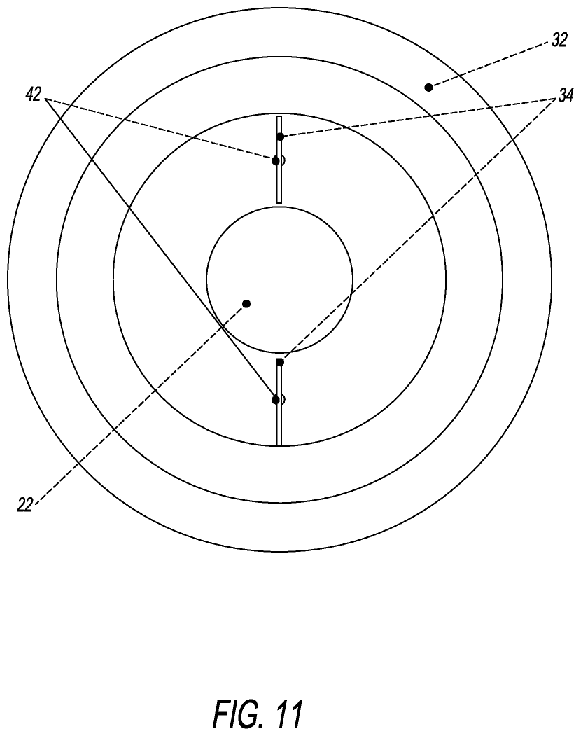

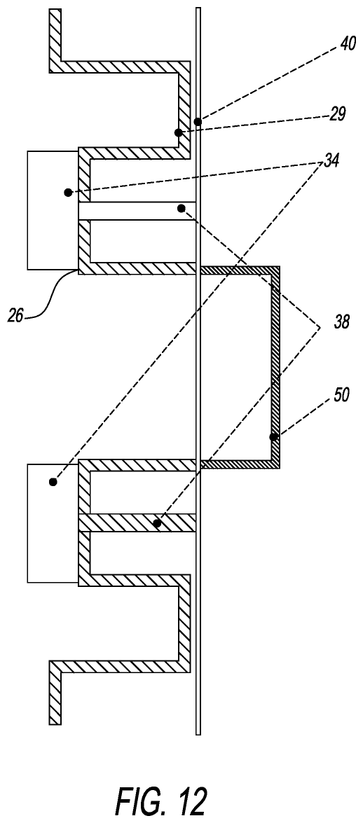

FIG. 10, FIG. 11 and FIG. 12 illustrate an embodiment having only two secondary antennas 34, which are arranged along a common line extending through the central axis of horn 21. The structure is otherwise similar to the embodiments described above.

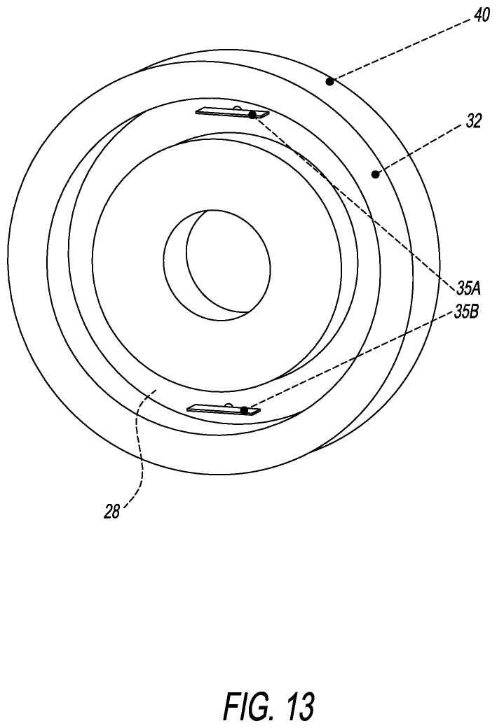

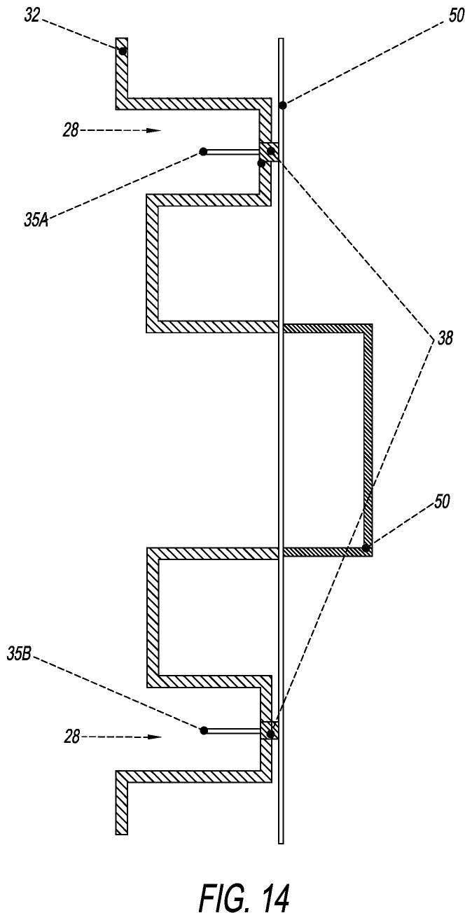

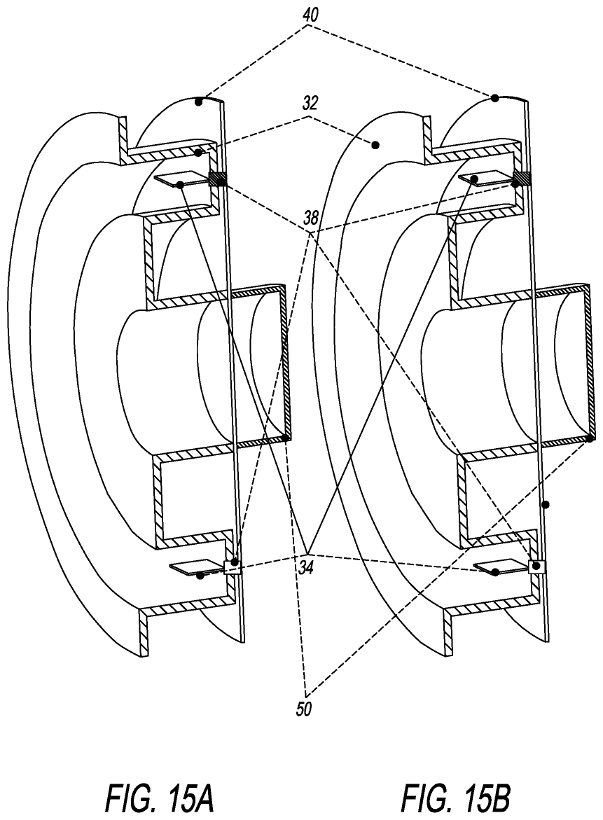

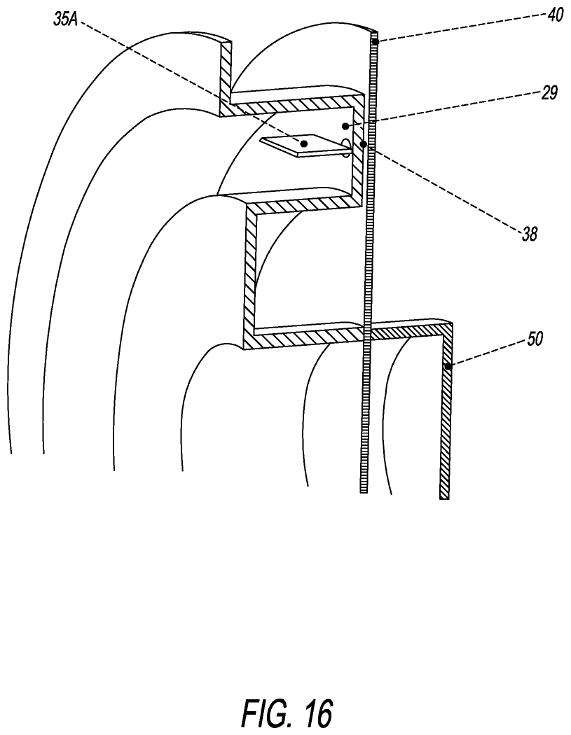

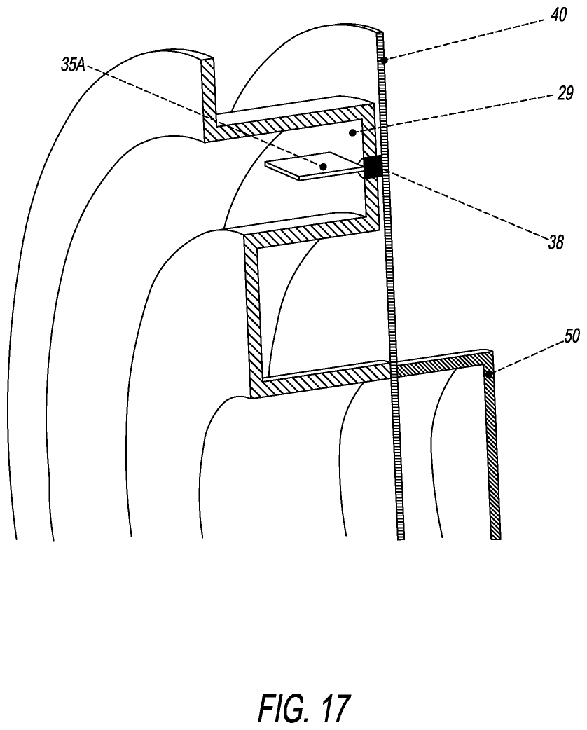

In the embodiment of FIG. 13, FIG. 14, FIG. 15A, 15B, FIG. 16, and FIG. 17, two secondary antennas 35A and 35B are disposed in channel 28. The bottom plane of channel 28 serves as the ground plane for antennas 35A and 35B.

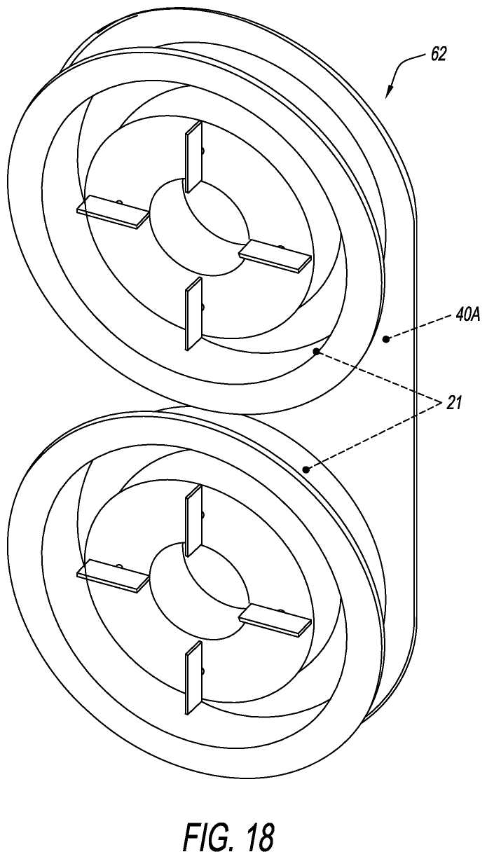

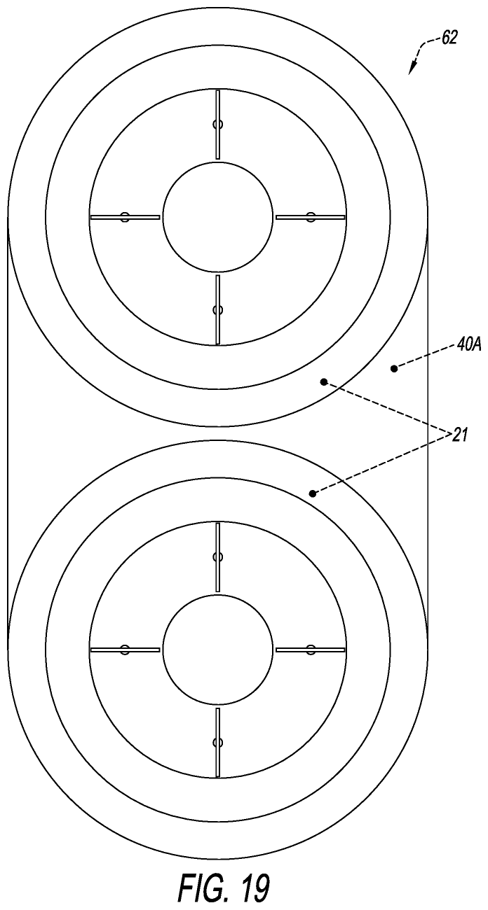

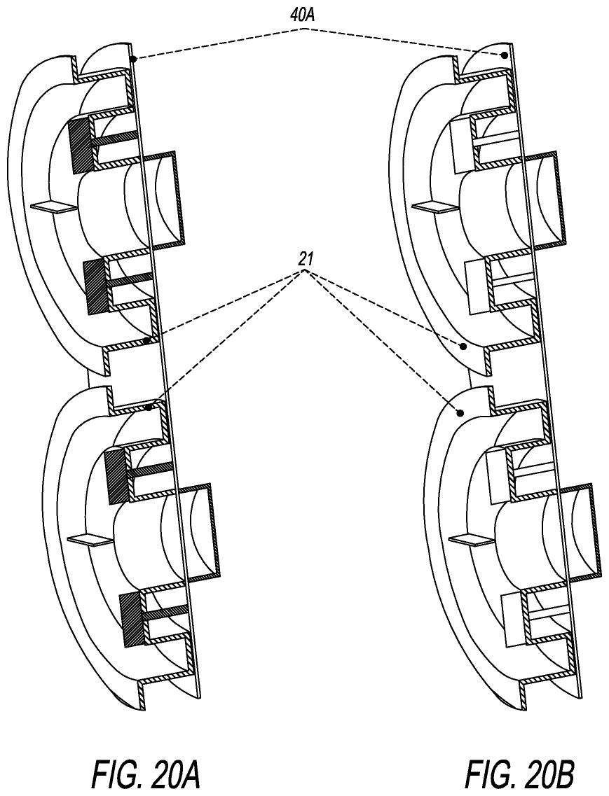

FIG. 18, FIG. 19, FIG. 20A and FIG. 20B illustrate an antenna embodiment 62, wherein two horns 21A and 21B are mounted on a single circuit board 40A

The structures and arrangements described herein are exemplary, and should not be construed as implying any particular limitation on the present disclosure. It should be understood that various alternatives, combinations and modifications could be devised by those skilled in the art. The present disclosure is intended to embrace all such alternatives, modifications and variances that fall within the scope of the appended claims. For example, the functioning of the antenna systems disclosed herein is not dependent on a particular type, arrangement, or configuration of the secondary antennas. However, the position and orientation of these antennas or their elements can define the radiation characteristics. Normally, suitability of a model of these antennas, and their orientation, is evaluated, for example, by means of 3D electromagnetic simulation and optimization, that is used to achieve desired performance. Factors such as mutual coupling or isolation between antennas can affect performance of the antenna system.

Each embodiment disclosed herein has some advantages and disadvantages, there are a plethora of possible arrangements of secondary antenna type, position, mutual orientation, to meet different target performance goals for each application. For example, using two secondary antennas, suits 2×2+2×2 DBDC (dual band dual concurrent) wifi chips.

The terms “comprises” or “comprising” are to be interpreted as specifying the presence of the stated features, integers, steps or components, but not precluding the presence of one or more other features, integers, steps or components or groups thereof.

What is claimed is:

1. An antenna system comprising:
a horn for radiating at a first frequency and having a first radio frequency connection for coupling to the to the horn;
at least one secondary antenna for radiating at a secondary frequency positioned on a surface of the horn; and
for each secondary antenna, a second radio frequency connection for radio frequency coupling to of the secondary antenna;
a planar structure connected to the horn for minimizing length of the radio frequency connections to thereby reduce radio frequency losses.

2. The antenna system of claim 1, wherein the planar structure is a printed circuit board.

3. The antenna system of claim 2, wherein the printed circuit board further comprises application circuitry.

4. The antenna system of claim 1, wherein the planar structure is disposed on a side of the horn opposite to a side on which the at least one secondary antenna is disposed.

5. The antenna system of claim 4, wherein the printed circuit board further comprises application circuitry.

6. The antenna system of claim 1, wherein the horn has a geometrically symmetrical portion that is circular, rectangular, square, or a combination thereof.

7. The antenna system of claim 6, wherein the secondary antennas are mounted on the geometrically symmetrical portion so that the geometrically symmetrical portion serves as a ground plane for the secondary antennas.

8. The antenna system of claim 1, wherein the horn has a recessed channel, and the at least one secondary antenna is mounted in the recessed channel.

9. The antenna system of claim 8, wherein, at some frequencies, a bottom surface of the recessed channel serves as a ground plane for the secondary antennas.

10. The antenna system of claim 1, comprising four secondary antennas.

11. The antenna system of claim 10, wherein the secondary antennas are disposed along at least one line extending perpendicularly from a central axis of the horn.

12. The antenna system of claim 10, wherein the secondary antennas are disposed along two lines extending perpendicularly from a central axis of the horn, the lines being perpendicular so that the secondary antennas are disposed at ninety degree intervals in a plane perpendicular to a central axis of the horn.

13. The antenna system of claim 10, wherein the secondary antennas are disposed along three parallel lines in a plane perpendicular to a central axis of the horn,
a first secondary antenna and a second secondary antenna being disposed along a first of the lines that intersects the central axis of the horn;
a third secondary antenna being disposed along a second line parallel to the first line; and
a fourth secondary antenna being disposed along a third parallel line parallel to the first line.

14. The antenna system of claim 1, comprising two secondary antennas.

15. The antenna system of claim 1, wherein the horn has a geometrically symmetrical portion, and the secondary antennas are mounted on the geometrically symmetrical portion so that the geometrically symmetrical portion serves as a ground plane for the secondary antennas.

16. The antenna system of claim 1, wherein the horn antenna has a recessed channel, and secondary antennas are mounted in the recessed channel so that a bottom surface of the recessed channel serves as a ground plane for the secondary antennas.

17. The antenna system of claim 16, wherein the secondary antennas are parallel to one another.

18. The antenna system of claim 1, wherein the horn operates in multiple frequency bands.

19. An arrangement of antennas, comprising:
a plurality of the antenna systems as set forth in claim 1; and
a common printed circuit board on which the plurality of antenna systems are mounted.

20. A method for assembling an antenna, comprising:
providing a printed circuit board with a first radio frequency feed for conducting radio frequency energy in a first frequency band;
providing, on the printed circuit board, at least one second radio frequency feed for conducting radio frequency energy in a second frequency band;
coupling a horn antenna to the printed circuit board so that the first feed provides radio frequency coupling to the horn antenna; and
coupling the at least one second radio frequency feed to respective secondary antennas disposed on the horn antenna.
